(19) United States
(12) Patent Application Publication
(10) Pub. No.: US 2010/0082449 A1
(43) Pub. Date: Apr. 1, 2010

(54) ELECTRONIC COMMERCE PRIVACY PROXY

(76) Inventor: Hugh Plautz, La Jolla, CA (US)

Correspondence Address: Workman Nydegger;1000 Eagle Gate Tower, 60 East South Temple, Salt Lake City, UT, 84111, US

(21) Appl. No.: 12/565,686

(22) Filed: Sep. 23, 2009

Related U.S. Application Data
(60) Provisional application No. 61/099,475, filed on Sep. 23, 2008.

(51) Int. Cl. G06Q 30/00; G06Q 50/00; G06F 3/01

(52) U.S. Cl. 705/26; 705/27; 715/744

(57) ABSTRACT

The present invention extends to methods, systems, and computer program products for exchanging gifts anonymously. Embodiments of the invention facilitate conducting electronic commerce transactions while maintaining anonymity of a gift recipient relative to a gift sender. For example, online friends can exchange gifts in the physical world while maintaining privacy. Embodiments of the invention can be integrated into existing social networking and dating Web sites to provide additional user benefits on behalf of the Web sites. Social networking and dating Web sites can partner with online stores that pay the social networking and dating Web sites a commission on generated sales. A gifting site can implement a privacy fee to maintain user privacy. The privacy fee can be assessed to each transaction to purchase a gift.

### CROSS-REFERENCE TO RELATED APPLICATIONS

This application claims priority to U.S. Provisional Patent Application Ser. No. 61/099,475, filed Sep. 23, 2008, and entitled “Exchanging Gifts Anonymously”, which is herein incorporated by reference in its entirety.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data.

Computer networks have simplified many aspects of everyday life. Many tasks can be performed much more efficiently using electronic communication on a computer network. For example, search engines have significantly increased the efficiency of finding information of interest. Further, many vendors, such as, for example, grocery stores, department stores, etc., allow items to be purchased “on-line”. Many vendors do not even have physical locations. These vendors receive orders over the Internet and ship purchased items out to designated addresses. This model permits purchasers to send items as gifts to other recipients.

For example, when one person desires to send another person a gift, such as candy or flowers, there are established vendors (e.g., FTD florists, Candygrams, etc.) in place for carrying out the request. Many, if not all, such vendors include capabilities to take orders over computer networks, such as, for example, the Internet. To submit an order, a sender provides a name and an address of the intended recipient along with form of payment. Thus, using these mechanisms it is convenient for one person to send a gift to another person.

However, these mechanisms also have at least two drawbacks. In some situations, one person may find it undesirable to receive a gift from another person. For example, if a sender and intended recipient meet for business purposes at a restaurant, there may be no need for the intended recipient to disclosure their home or business address. However, if the sender is aware of a location for the intended recipient's place of business, the sender can send a gift to the intended recipient at his or her place of business. As such, gift delivery is potentially still possible by directing the gift to the specified location where the intended recipient may be found, for example, at a business where a meeting took place, at a location mentioned by the intended recipient, or where he or she is regularly present.

Unfortunately, the convenience and flexibility conferred on a gift-giver to have a gift successfully delivered without having full name and/or personal address information is often undesirable and potentially annoying to a recipient. That is, one person may not desire such attention (e.g., receiving a gift) from another person, who is likely an acquaintance at best. None the less, those interacting with members of the public in the workplace, or casually meeting strangers in social situations, are subject to being sent unwelcome gifts.

On the other hand, in other situations, without any address or delivery-location information gift delivery is not possible. For example, in a social setting a person may chose to reveal their full name to another person. However, without address information the person may have no way to send a gift to the other, since the person is not aware of any locations associated with the other user. That is, delivery may be impossible based solely on a name. So, absent some further research or word-of-mouth inquiry by a gift-giver, gift delivery is essentially impossible. However, in contrast to the intended recipient who might shun a gift, others might be disappointed if they knew that a new acquaintance had such generous intentions, without any way to carry them out.

People who interact electronically with others over the Internet and the World Wide Web normally use pseudonym as a screen name or handle. Use of a pseudonym essentially allows a person to remain unidentified while they chat on-line, send instant messages, send e-mail exchange photographs, exchange voice messages, etc. Thus use of a pseudonym protects a person's primary identity, essentially preserving the anonymity of the person. However, due to the pseudonymity of friendships and relationships established through electronic communication, there is virtually no way for one person to send a gift to another person, unless the prospective recipient is willing to reveal his or her true name and address.

### BRIEF SUMMARY

The present invention extends to methods, systems, and computer program products exchanging gifts anonymously. A gifting site is connected via network communication with partner sites and shopping partners, the gifting site computer system including a processor and system memory. A giftor accesses a partner site profile for a giftee from the partner site. The giftor selects a user-interface control to select a gift profile for giftee. The gift site receives an indication that a giftor at the partner site selected a user-interface control within a partner site profile to select a gift profile for a giftee. The gift site sends the gift profile for the giftee to the partner site.

The partner site receives the gift profile from the gifting site. The partner site presents the gift profile at a client computer system to appear to be from the partner site. The partner site receives a selection from the giftor to browse gifts for the giftee. The partner site sends the selection from the giftor to the gifting site. The gift site receives the selection from the giftor to browse gifts for the giftee.

The gift site returns a shopping interface for one or more shopping partners to the partner site. The partner site receives and presents the shopping interface for one or more shopping partners from the gifting site. The giftor selects an item from the shopping interface to send to the giftee and an identifier identifying the giftee.

The gifting site receives the selection the item from the shopping interface to send to the giftee and a giftee identifier identifying the giftee. The gifting site obtains address information for the giftee based on the giftee identifier. The address information is stored in encrypted format at the gifting site. The gifting system sends a purchasing request to a shopping partner to purchase the item for the giftee. The purchase request indicates that the gifting site is the sender and that the item is to be shipped to the giftee's address.

Subsequently, the giftor and/or the giftee can receive one or more messages indicating the progression of the transaction to send the item to the giftee as a gift. The one or more messages including tracking information that maintains the privacy of the giftee and the giftor.

In other embodiments, a partner site is configured for anonymous gift exchange. The gift site receives an indication that a partner site desires to participate in anonymous gift giving. The gift site configures a Web service to interact with the partner site such that the partner site does not have to be modified to interact with the gifting site. The gift site utilizes the Web service to receive data to establish a relationship between the gifting system and partner site such that the partner site can interact with other partner sites to participate in anonymous gift giving transactions.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates configuring anonymous gift exchange.

FIG. 1B illustrates an example computer architecture that facilitates anonymous gift exchange.

FIG. 2 illustrates a flow chart of an example method for exchanging a gift anonymously

FIGS. 3A-3D depict screens of a shopping user interface.

### DETAILED DESCRIPTION

The present invention extends to methods, systems, and computer program products for exchanging gifts anonymously. A gifting site is connected via network communication with partner sites and shopping partners, the gifting site computer system including a processor and system memory. A giftor accesses a partner site profile for a giftee from the partner site. The giftor selects a user-interface control to select a gift profile for giftee. The gift site receives an indication that a giftor at the partner site selected a user-interface control within a partner site profile to select a gift profile for a giftee. The gift site sends the gift profile for the giftee to the partner site.

The partner site receives the gift profile from the gifting site. The partner site presents the gift profile at a client computer system to appear to be from the partner site. The partner site receives a selection from the giftor to browse gifts for the giftee. The partner site sends the selection from the giftor to the gifting site. The gift site receives the selection from the giftor to browse gifts for the giftee.

The gift site returns a shopping interface for one or more shopping partners to the partner site. The partner site receives and presents the shopping interface for one or more shopping partners from the gifting site. The giftor selects an item from the shopping interface to send to the giftee and an identifier identifying the giftee.

The gifting site receives the selection the item from the shopping interface to send to the giftee and a giftee identifier identifying the giftee. The gifting site obtains address information for the giftee based on the giftee identifier. The address information is stored in encrypted format at the gifting site. The gifting system sends a purchasing request to a shopping partner to purchase the item for the giftee. The purchase request indicates that the gifting site is the sender and that the item is to be shipped to the giftee's address.

Subsequently, the giftor and/or the giftee can receive one or more messages indicating the progression of the transaction to send the item to the giftee as a gift. The one or more messages including tracking information that maintains the privacy of the giftee and the giftor.

In other embodiments, a partner site is configured for anonymous gift exchange. The gift site receives an indication that a partner site desires to participate in anonymous gift giving. The gift site configures a Web service to interact with the partner site such that the partner site does not have to be modified to interact with the gifting site. The gift site utilizes the Web service to receive data to establish a relationship between the gifting system and partner site such that the partner site can interact with other partner sites to participate in anonymous gift giving transactions.

Embodiments of the present invention may comprise or utilize a special purpose or general-purpose computer including computer hardware (e.g., processors and system memory), as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention include an integrated anonymous gifting application. The gifting application can be integrated with a partner site (e.g., a social networking site) such that gifting application appears as part of the site. For example, user-interfaces can be built using cascading style sheets (“CSS”) so as to “take on” a partner site's identity. Thus, a gifting profile from the gifting application can appears as a profile of the partner site. A connectivity module facilitates efficient set-up between the gifting application and a partner site. Partner site specific user gift profiles can be at least partial populated from data in partner site profiles. Web services can be configured between the gifting application and a partner site to access partner site profile data.

The messaging application can send various messages and notifications during an anonymous gift giving transaction. Messages and notifications can be sent to inboxes at the gifting application, inboxes at the partner site, and/or to other electronic mail inboxes. Messages can include indication of a sent gift, a received gift, that a gift is on the way, that someone would like to send a gift to you, that your gift got rejected, that your gift was successfully delivered, etc.

The gifting application also includes an electronic commerce module that facilitates the electronic purchase of gifts. The electronic commerce module includes a partner site administration/reporting model, a shopping partner administration/reporting model, a gifting application administration/reporting model, various Web services for communicating with partner sites and shopping partners, and a shopping module for making gift purchases. A gift/tracking order status module can also be used to follow the progress of a gift transaction.

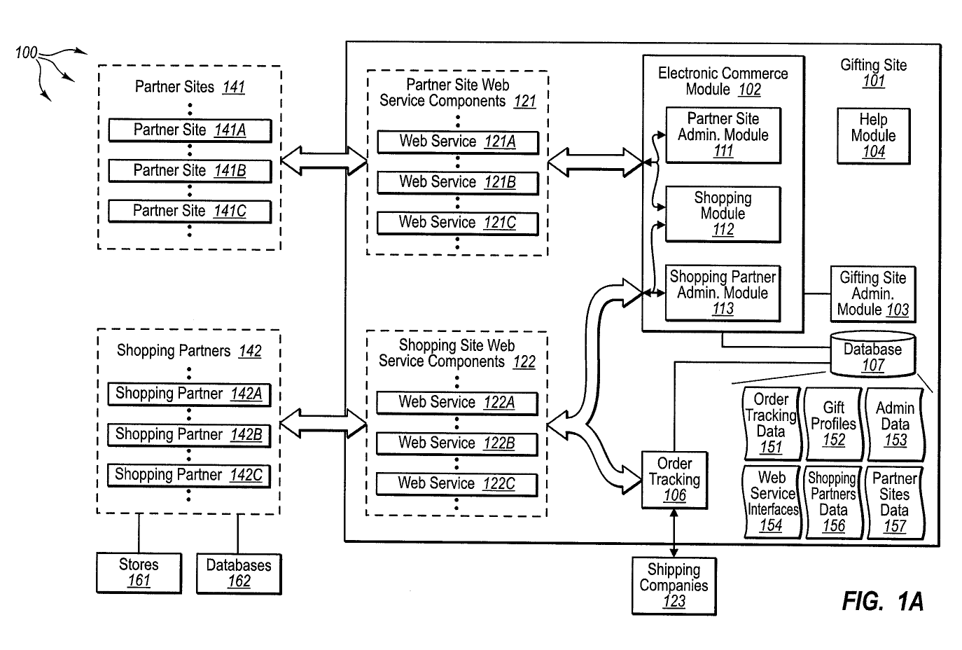

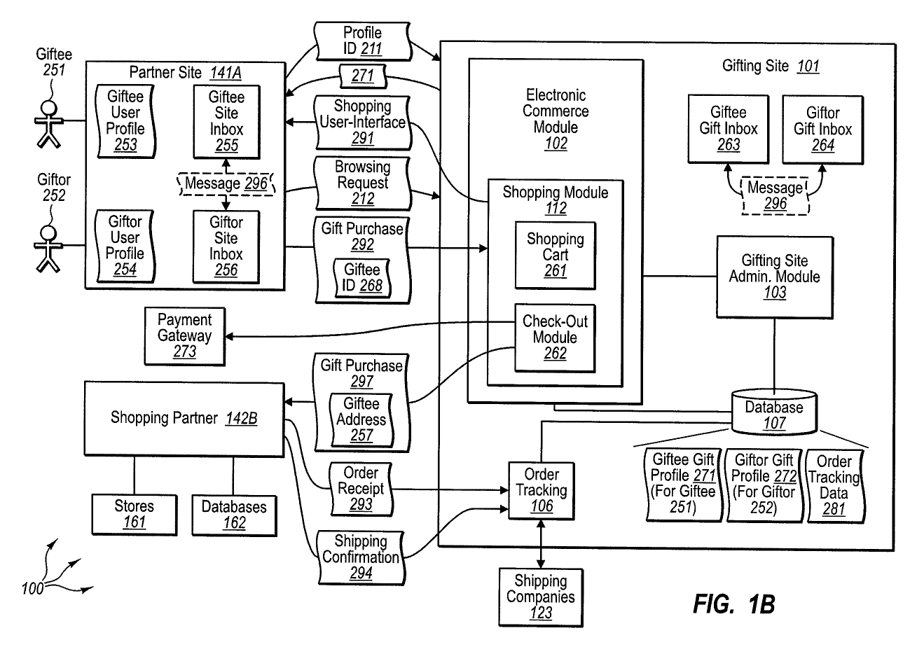

FIG. 1A illustrates an example computer architecture 100 that facilitates configuring anonymous gift exchange. Referring to FIG. 1A, computer architecture 100 includes partner sites 141, gifting site 101, shopping partners 142, stores 161, databases 162, and shipping companies 123. Each of the depicted components is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (“SOAP”), etc.) over the network. The exchanged messages can include HyperText Markup Language (“HTML”) instructions, eXstensible Markup Language (“XML”) instructions, as well as other instructions and data.

As depicted, partner sites 141 include a plurality of partner sites including partner sites 141A, 141B, and 141C. Each partner site can be a social or business networking (e.g., Web) site or even a dating (e.g., Web) site that is partnered (or intends to partner) with gifting site 101 (e.g., also Web site). Each partner site can have an existing user or member base. Users can access a partner site to communicate with other users of the partner site with some level of anonymity. For example, each user of a partner site can establish a pseudonym by which they are known. Users can send communication to pseudonyms to communicate (voice, instant message, text, electronic mail, etc.) with one another without having to know actual names, addresses, etc. of other users.

As depicted, shopping partners 142 include a plurality of shopping partners including shopping partners 142A, 142B, and 142C. Each shopping partner can be an electronic commerce (e.g., Web) site that is partnered (or intends to partner) with gifting site 101. A shopping partner can present items for sale from any of a variety of different stores in stores 161 and/or any of a variety of different databases in databases 162. Shopping partners can provide a (e.g., graphical) shopping interface through which individuals can purchase items through the shopping partner. The shopping partner then initiates delivery of a purchased item to an intended recipient. For example, a shopping partner can contact a shipping company in shipping companies 123 to deliver an item

As depicted, gifting site 101 further includes partner site Web service components 121, shopping site Web service components 122, electronic commerce module 102, help module 104, gifting administration module 103, database 107, and order tracking 106.

Database 107 can store a variety of different types of data used by gifting site 101. As depicted, database 107 stores order tracking data 151, gift profiles 152, admin data 153, web services interfaces 154, shopping partners data 156, and partner sites data 157. Generally, gifting site 101 can use order tracking data (in combination with interacting with shipping partners 123) to provide tracking information to giftees and/or giftors without revealing personally identifiable information. Gift profiles 152 containing gifting preferences, such as, for example, types of gifts and who can send gifts, for users of partner sites that have chosen to participate in anonymous gift exchange. Admin data 153 contains administrative data related to the operation of gifting site 101 and that can be accessed and manipulated via gifting site admin. module 103.

Web services interfaces 154 contain standard and/or customized templates for configuring gifting site 101 to interoperate with parent sites and shopping partners. Generally, a Web service is software (e.g., application program interfaces) designed to support interoperable machine-to-machine interaction over a network (e.g., the Internet). Web services can be executed on a system hosting a requested services or a system requesting a service. For example, Web services can be used to compatibly communicate between computer systems that communicate using XML messages that follow the SOAP standard. A machine readable description of operations offered by a service can be written in a service language, such as, for example, Web Services Description Language (“WSDL”). A Web service description can be used for automated client-side code generation.

Partner sites data 157 contains administrative data related to the operation of partner sites 141 and that can be accessed and manipulated via partner site admin. module 111. Shopping partner data 156 contains administrative data related to the operation of shopping partners 142 and that can be accessed and manipulated via shopping partner admin. module 113.

Accordingly, electronic commerce module 102 configures partner sites 141 and shopping partners 142 to participate in anonymous gift purchases and to implement anonymous purchases for gifts. Partner site administration module 111 can configure gifting site 101 for use with partner sites 141. Likewise, shopping partner administration module 113 can configure gifting site 101 for used with shopping partners 142. Information for facilitating these functionalities can be exchanged over a network, such as, for example, the Internet, using Web services.

As depicted, gifting site 101 has access to partner site Web service components 121. Partner site Web service components 121 include Web services 121A, 121B, 121C, etc. Each of Web services components 121 can be configured for compatible communication with a corresponding partner. Thus, Web service components 121 facilitate communication between a partner site and gifting site 101 without modifications to the partner site. For example, Web service 121A can facilitate compatible communication between partner site 141A and gifting service 101 without having to modify partner site 141A. Users at each partner site can have profiles that contain information about the users. Users can also chose to enter further information into a gift profile that is maintained at gifting site 101 (although it may appear as part of the partner site).

As depicted, gifting site 101 also has access to shopping site Web service components 122. Shopping site Web service components 122 include Web services 122A, 122B, 122C, etc. Each of Web service components 122 can be configured for compatible communication with a corresponding shopping partner. Thus, Web service components 122 facilitate communication between a shopping partner and gifting site 101 without modifications to the shopping partner. For example, Web service 122B can facilitate compatible communication between shopping partner 142B and gifting service 101 without having to modify shopping partner 142B.

Accordingly, the use of Web services permits new partner sites and new shopping partners to be efficiently added. For example, a connectivity module can be used to setup new partner sites and shopping partners and connect to gifting system 101. Portions of gifting system 101 can be launched in new windows that are private label branded through CSS programming and facilitate a unique custom look and feel per partner site. Gift site 101 can provide publicly and privately viewable icons.

Public icons permit a primary (although not exclusive) launching point for gift site 101. These are icons available on end-user profile pages as site visitors are browsing site partner profile pages. Publicly viewed icons are made available on the end-user profile, can be text and/or graphics. Public icons can be used to launch different experiences including “Shop for this person” (launches an electronic commerce module) and “View Gift Profile” (launches a public portion of a User Profile Module).

Private icons are available to a user that is logged into his or her profile. Private icons can launch the private/setup sections of the user profile module. Partner sites may choose to have gifting available automatically to all members or may opt to have it available only to members who opt-in to create a gift profile utilizing the user profile module. In either case, the basic profile information can be pulled from existing information contained in the partner site profile.

Partner site application links can indicate to gifting site 101 which partner site the application is communicating with. These can be links or some other type of programming so that the system always knows which partner site the application is dealing with. For example, profile application links can tell the gifting site 101 which giftor and giftee the application is communicating with and about.

Generally, a giftor is a person who desires to give a gift to another person. A giftee can browse profiles and initiate a shopping session. The giftor may be unknown during browsing sessions unless the person has already signed into his or her partner site profile. The giftor may not even be known if the person has signed into his or her partner site profile. However, upon checkout the user is asked to create a gift profile.

Generally, a giftee is a person targeted to receive a gift. A giftee may not have a gift profile. A giftor can send a message to the giftee requesting that they create a gift profile so that he or she may receive a gift. A giftee may be known to a giftor through other mechanisms. For example, a giftor can click on the “buy this person a gift” link or icon in the giftee's partner site profile. A giftee can change during the shopping experience. For example if a user clicks on a giftee icon in curiosity, but decides they would actually like to purchase a gift for a different giftee, user can change the giftee by typing in the new giftee's gift profile user name.

Gifting site 101 can prevent the purchase of a gift unless both the giftor and giftee have a gifting profile.

In some embodiments, fields included in a gift profile are already contained in a partner site database. Thus, to establish a gift profile for a user of a partner site, gifting site 101 can access data from the user's profile of the partner site. A user profile can be site specific to that the partner site gets credit. A Web service can be used to pull profile data from a partner site. For example, Web service 121A can be used to pull profile data from partner site 141A. Accordingly, partner site administration module 111 can facilitate a connection between gifting site 101 and partner site 141A to access various portions of profile data. Access profile data can include a user's profile name/ID, a default photograph, contact information (e.g., address, city, state, etc.), payment information (e.g., a default credit card, etc.), etc.

Profile data can be stored in an encrypted format both at the partner site and at gifting site 101 (e.g., in database 107 as gift profiles 152). Profile data can also be encrypted during transfer from the partner site to gifting site 101. A user can fill out other fields in a gift profile to provide further data related to sending and receiving gifts. Thus, a gifting profile can contain a variety of different information some of which is private to the user and some of which is publicly viewable to other users and some of which is profile data form a partner site and some of which supplements profile data from a partner site.

For example, a gifting profile can include a gifting site name/ID. A gifting site name/ID can default to the user's partner site profile name/ID. In some embodiments, the gifting site name/ID is unique across all partner sites. A gifting profile can also include one or more of: a photograph, a ship to address, a bill to address, payment details, a password, an associated electronic.

In some embodiments, a gift profile also includes more detailed gifting information relevant to a user. For example, a gift profile can include birthdays, anniversaries, and/or other user created gift days indicating a day when the user may be desirous of receiving a gift. A user created gift day can include a date, title, and description. A gift profile can also include a wish list of gifts and specific dislikes for gifts a user does not like. A gift profile can also include gift preferences on who can send gifts to a user, such as, for example, anyone, other users on the same network (e.g., friends), only selected other users, or no one.

A gift profile can include some or all of these types of data can be stored in an encrypted format in database 107. Accordingly, there can be two icons next to a partner site profile when viewed at a partner site. One that icon represents “shop for this person” and another one that represents “gift profile.” When a partner site profile is browsed at the partner site a potential giftor can click a “gift profile” icon to access a potential giftee's gift profile. In response to selecting “gift profile” icon, gifting site 101 can open up a new window that is controlled by gifting site 101. The window can include one or more of: a photograph of the potential giftee, a gift site ID, gift preferences, wish lists, and shopping links. Shopping links can be provided then a potential giftor matches the gift preferences for the potential giftee (e.g., the potential giftor is in the potential giftee's network or is a selected user). Shopping links can include a shop for link that launches an electronic commerce application, such as, for example, shopping module 112

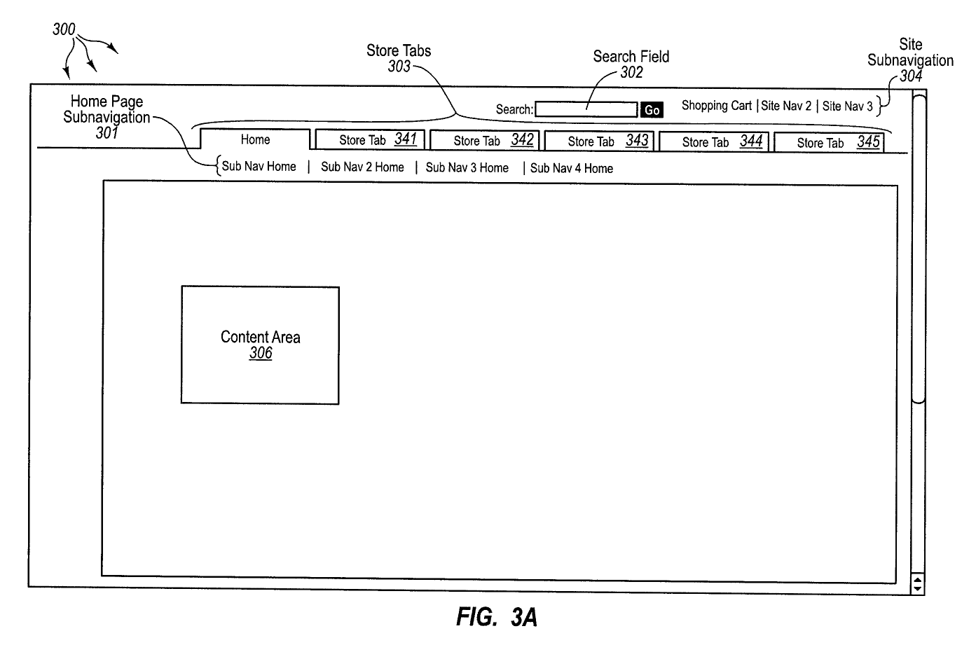

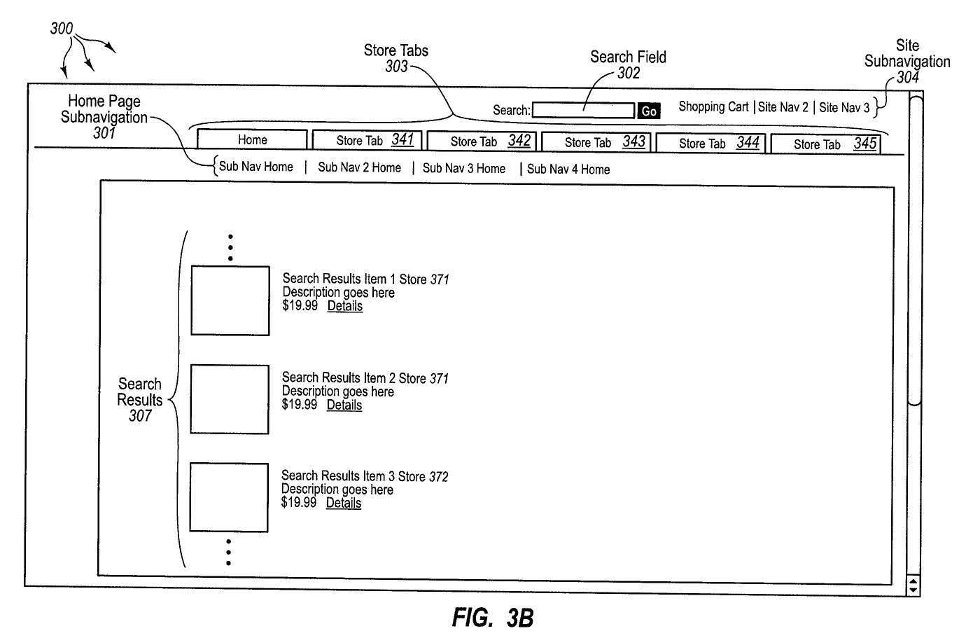

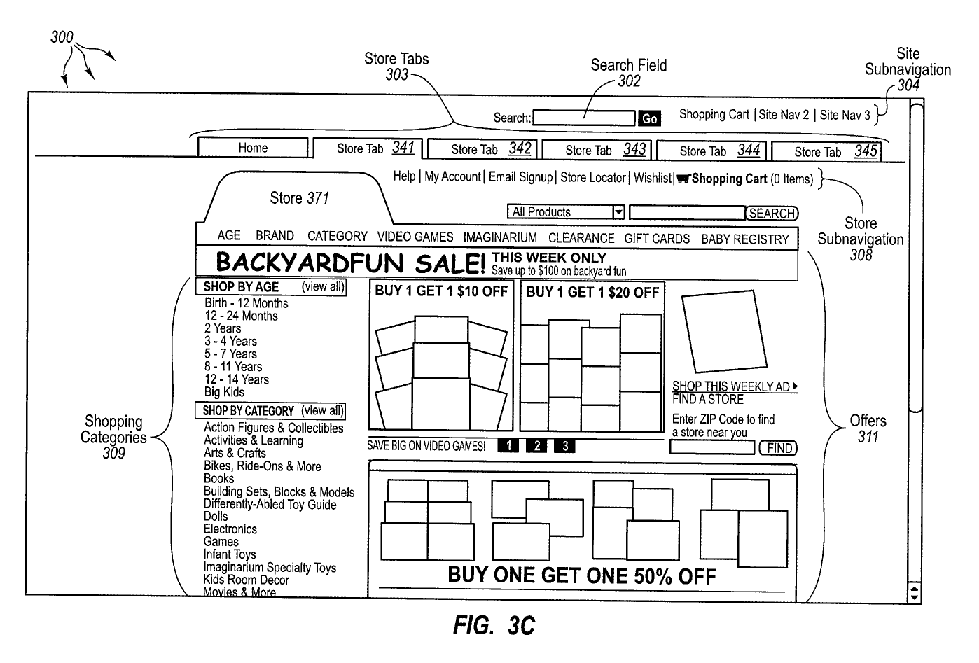

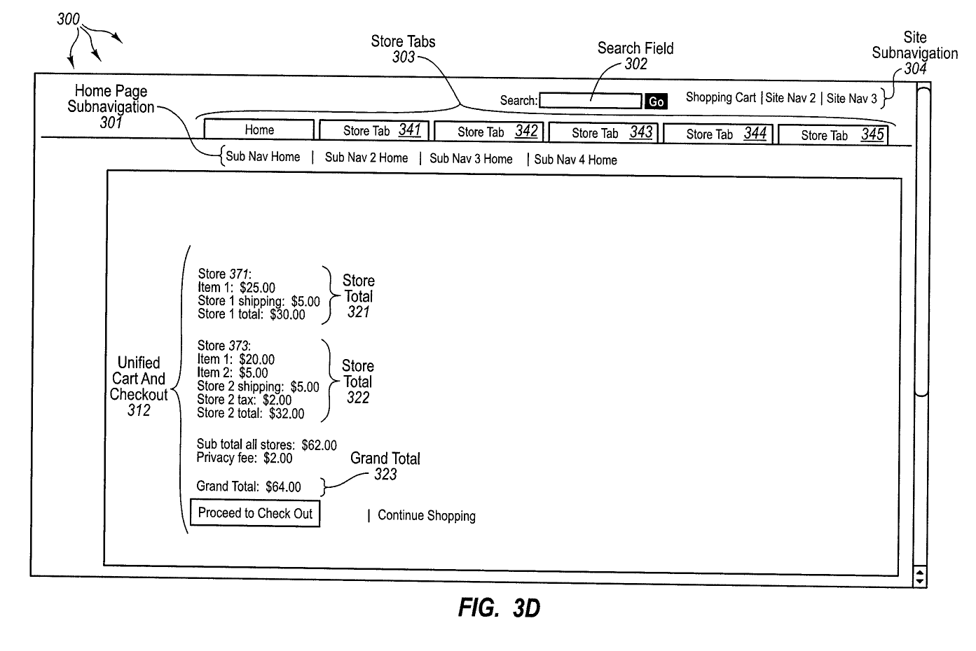

Electronic commerce module 102 and more specifically shopping module 112 can electronically purchase items (gifts) over a computer network. Shopping module 112 can be launched when a user is browsing partner site profiles and clicks on the “shop for this user” or is viewing a gifting site 101 user's profile and clicks on the “shop for this user's” link. Shopping module 112 can be launched in a new window. Shopping module 112 can operate under a set of prosperities, including: adding a privacy fee, a complete shopping cart system, a database of order information, giftor credit card charging (through any of a variety of different credit card processing gateways). For example, shopping cart 261 and check-out module 262 can interoperate to provide a complete shopping cart and check-out system for any and all shopping partners of gifting system 101 (e.g., as depicted in FIG. 3D).

A privacy fee can be assessed by gifting site 101 per order no matter how many items are in the order. The complete shopping cart system can span multiple shopping partners. The complete shopping cart system can provide totals and add shipping totals by store, which can then be added together into a grand total.

A shopping cart window can contain up to a specified number of stores that are accessed by tabs on the screen. A small photo (from the gift profile) can be included above these links along with wish lists from gifting site 101 for the user whose profile activated the shopping experience. Accordingly, a potential giftor is given a clear indication of what a potential giftee desires.

A shopping experience can include customized look and feel for each store. Main navigation can be defined by gifting site 101, while sub-navigation is defined by the individual stores. Sub-navigation can be set up through shopping partner administration module 113. Each store can include shopping categories as they see fit, including: shop by age, shop by subject matter, impulse items, shop by price, etc.

Help module 104 can provide help to partner site users, for example, indicating how to establish a gift profile, purchase items, etc. Help module 104 can launch a new window from various parts of the gifting site 101 to address any of: shipping FAQs, shipping charges, delivery confirmation, order status, privacy charge, about Gifting, creating a profile, and safety FAQs.

Gifting site administration module 103 can be included as part of management system used by administrators and/or employees of gifting site 101.

Database 107 can store data (in encrypted form) for any partner sites (gift profiles 152 and partner site data 153) and shopping partners (shopping partner's data 156). Database 107 can also store administrative data 153 for use in the maintenance of gifting site 101. Database 101 can also store Web service interfaces 154 providing components for Web services (e.g., 121 and 122) facilitating electronic communication with partner sites and shopping partners.

Order tracking 106 can interact with shipping companies 123 to track orders for gifts. Order tracking 106 can make tracking information available to a giftor and giftee without revealing private information about either party.

Shopping partners can use shopping partner administration module 113 to administer an electronic commerce store. Employees of gift site 101 can initially set up CSS templates for a shopping partner and can assist the shopping partner to set up appropriate store navigation. Shopping partner administration module 113 permits shopping partners to design the specific configuration and sub-navigation of their shopping partner site. For example, shopping partners can use shopping partner administration module 113 to select a shopping cart template, Add/Modify/Delete Sub-navigation, Add/Modify/Delete Categories, Add/Modify/Delete Products, Add/Modify/Delete Promotions, Stock/shipping information live link (if available from shopping partner site), and delete customer comments.

Shopping module 112 can display stores for each partner site uniquely. Thus, partner site 141A's shopping partners can differ from partner site 141B's shopping partners. Gifting site 101 can display the appropriate stores based on the partner site whose gift profile launched the shopping experience. Each partner site can chose their own shopping partners. Gifting site 101 may have some default partners chosen for turnkey implementation. Shopping partners can pay the partner site a commission for each sale.

Shopping module 112 does not necessarily attempt to recreate a shopping partner's entire Web presence. Shopping module 112 can provide a subsection of all the partner store has to offer. The benefit to the partner store is they have access to hundreds of millions of new potential transactions between people that may have no other way to send gifts outside of gifting site 101 and still maintain their personal privacy.

FIG. 1B illustrates an example computer architecture that facilitates anonymous gift exchange. As depicted, giftee 251 and giftor 252 are users at partner site 141A. Giftee 251 has giftee user profile 253 and giftee site inbox 255 at partner site 141A. Similarly, giftor 252 has giftor user profile 254 and giftor site inbox 256 at partner site 141A. Giftee 251 also has giftee inbox 263 at gifting site 101. Giftor 252 also has giftee inbox 264 at gifting site 101.

Giftor 252 can access giftee gift profile 271 at partner site 141A and select an option to purchase a gift for giftee 251. In response, giftor 252 can be directed to a user interface for shopping partner 142B. Electronic commerce module 102 can also check to see if giftee 251 is willing to receive a gift from giftor 252. For example, electronic commerce module 102 can determine if giftor 252 is a friend of giftee 251, if giftee 251 is willing to receive gifts from anyone, etc. If giftee 251 is not willing to receive a gift from giftor 252, giftor 252 is notified as such.

FIGS. 3A-3D depicted user interface screens providing a shopping interface 300. For example, as depicted in FIG. 3A, shopping interface 300 includes home page 301, search field 302, store tabs 303 (including store tabs 341, 342, 343, 344, and 345), site sub-navigation 304, and specials 306. Home page 301 can represent the homepage for a gifting site, such as, for example, gifting site 101. Search filed 302 permits a search of partner shopping sites for terms of interest. Store tabs 303 represent tabs for each partner store, such as, for example, shopping partners 142A through 142C. Site sub-navigation 304 represents sub-navigation for individual shopping partners. Content area 506 can present system wide information, such as, for example, specials from individual shopping partner sites.

A user of shopping interface 300 can enter a term into search field 302 to search for items across all shopping partners. Turning, to FIG. 3B, as depicted in FIG. 3B, search results 307 includes items from different stores (include two items from store 341 and one item from store 343).

Generally, giftor 252 can select a store tab to be taken to the shopping partner site for the store. Turning to FIG. 3C, for example, user 252 can select store tab 341 to go to the shopping partner site for store 371. The shopping partner site for store 371 can include content, navigation, offers, and categories presenting a unique look and feel for store 371 (and different from that other stores). For example, as depicted, shopping partner site for store 371 includes store sub-navigation 308, shopping categories 309, and offers 311.

Giftor 252 can navigate these or other similar user interface screens to browse items from shopping partner 142B (or other shopping partners) and select an item or items to give to giftee 251 as a gift. Giftor 252 can make other selections to proceed to check-out module 262. Through interacting with payment gateway 273 check-out module can approved or disapprove of the purchase. If the purchase is approved, check-out module 262 sends gift purchase 297, including giftee address 257, to shopping partner 142B. Gift purchase 297 indicates that the purchaser of the gift if gifting site 101. Electronic commerce module 102 can use the ID for giftee 251 to retrieve giftee address 257 from giftee gift profile 271.

When all items are selected, giftor 252 can use a unified cart and checkout to complete purchases. Turning to FIG. 3D, for example, unified cart and check out 312 includes store total 321 for store 371 and store total 322 for store 373. Unified cart and check out 312 also includes grand total 323.

If the purchase is successful, shopping partner 142B returns order receipt 293 and later shipping confirmation 294 to order tracking 106. Order tracking 106 can store order receipt 293 and later shipping confirmation 294 in order tracking 251 for later inclusion in messages to giftee 251 and/or giftor 252. Order tracking 106 can also interact with shipping companies 123 on behalf of giftee 251 and/or giftor 252 to obtain further shipping information without divulging identity information.

A web service can facilitate interactions between gifting site 101 can shopping partner 142B. For example, a connection between gifting site 101 and shopping partner 142B using Web service 122 B can include exchanging various order data, including one or more of: products ordered, sub totals, shipping totals, tax totals, grand totals, a pseudonym for giftor 252, a (potentially) random transaction ID, complete store order information, a confirmation email (without personally identifiable information) to the giftor, a confirmation email to the giftee, shipping information (without personally identifiable information), etc.

Gifting site 101 orders can be assigned a unique shipping tracking ID. This tracking ID is sent to the giftor with order confirmation. Gifting site 101's shipping tracking ID has no correlation with the actual electronic commerce store's shipping tracking information. However, order shipping tracking IDs are mapped to gifting site 101 tracking IDs (e.g., in order tracking data 281). For each shopping partner an automated interface is set up to correspond the gifting site 101 shipping tracking ID with the actual partner tracking id.

Accordingly, if a shopping partner sends an email when an order has been shipped with a tracking ID, order tracking 106 performs a number of operations to preserve anonymity yet make a giftor and/or giftee aware of the order shipping. For example, order tracking 106 can strip out the tracking ID and enter it into the appropriate gift order tracking module database field. Order tracking 106 can send an electronic mail message to an electronic mail address of the giftor (e.g., to giftor gift inbox 264) with an indication that an order has shipped.

Unique order identification information can be used to distinguish different orders from the same giftor. Unique order identification information can include a tracking ID from gifting site 101, an order number for gifting site 101, giftee's screen name for gifting site 101, giftee's screen name for partner site 141A, giftee's partner site domain name, product(s) ordered, store where product(s) where purchased, etc. When items are purchased from multiple stores, updates can be presented on a per store basis. Order tracking modules can interface with shipping companies 123 tracking systems and stripping out personally identifying information.

Order tracking 106 can also replace a tracking ID from a shipping company with a tracking ID specified to gifting site 101. Order tracking 106 can maintain a mapping between gifting site 101 tracking IDs and shipping company IDs. Thus, order tracking 106 can obtain tracking information from shipping companies (using shipping company tracking IDs) without divulging shipping company tracking IDs to giftors and/or giftees.

Order tracking module 106 can also present a user interface that permits entry of a tracking ID or order ID to track a shipment. Based on a tracking or order ID, order tracking 106 can present tracking information with personally identifying information stripped out. For example, state and city information can be stripped out of tracking information returned from a shipping company and replaced with other information, such as, for example, “gift has arrived at giftee's state and/or city”. When a signature is required, the signers name can also be stripped out and replaced, for example, with “package has arrived and been signed for”. If a signature is not required, text, such as, for example, “package has been delivered” can be used.

During the transaction for the purchase of a gift various messages can be sent to different parties at different times. In some embodiments messages are sent and/received in accordance with various messaging rules. Messages can be sent to multiple destinations, including giftor's gift message inbox, giftor's partner site message inbox, giftor's electronic mail inbox, giftee's gift message inbox, giftee's partner site message inbox, gifte's electronic mail inbox. When messages are sent to inboxes outside of gifting site 101, the messages can contain only partial information along with a link back to inboxes at gifting site 101 to obtain complete message details. Thus, partial messages essentially drive users back to gifting site 101 for complete message details.

Messages can include an indication that a gift has been sent to you, that a gift has been sent from you, or that someone would like to send you a gift. A message indicating that a gift has been sent to a user can include an indication of who the gift is from. In response to a message that a gift has been sent to a user, the user can respond by rejecting future gifts and/or sending a message back to the giftor.

A message indicating that a gift has been sent from you can include links to the profiles of other users gifts have been sent to and links to order tracking 106

A message indicating that someone would like to send you a gift can indicate the potential giftor. In response to a message indicating that someone would like to send you a gift, the user can respond by rejecting or allowing the gift. The selection can be a onetime selection, can permanently add the giftor to a list of permitted giftor, or can permanently block the giftor from sending gifts.

Gifting site 101 can also provide various reporting services to partner sites and shopping partners. For example, shopping partner administration module 113 can provide sales reports including dates and product IDs.

Partner site administration module 111 can provide sales reports as well as allow the configuration of various partner site variables including: defining the number of stores that show up on an electronic commerce shopping interface (e.g., shopping interface 300), modify shopping partner information (contact information, commission %, partner site URL), add/modify/delete product categories, etc. From this information partner site administration module can run sales reports including one or more of: store, date, product IDs, and site categories. The sales reports can list sales by store totals, such as, for example, total number of sales, total value of sales, and total commission of sales.

Gifting site administration module 103 can also provided reports to employees of gifting site 101. Gifting site 101 administrators have various different levels permitting more or less access.

Gifting site administration module 103 builds on the functionality of shopping partner administration module 113 and shopping partner site administration module 111 to add an overarching level which drills down by partner site. Thus, an administrator of gifting site 101 can add/modify/delete partner sites, add/modify/delete global store templates, filter information by partner site, run sales reports for partner sites and shopping partners, search orders, etc.

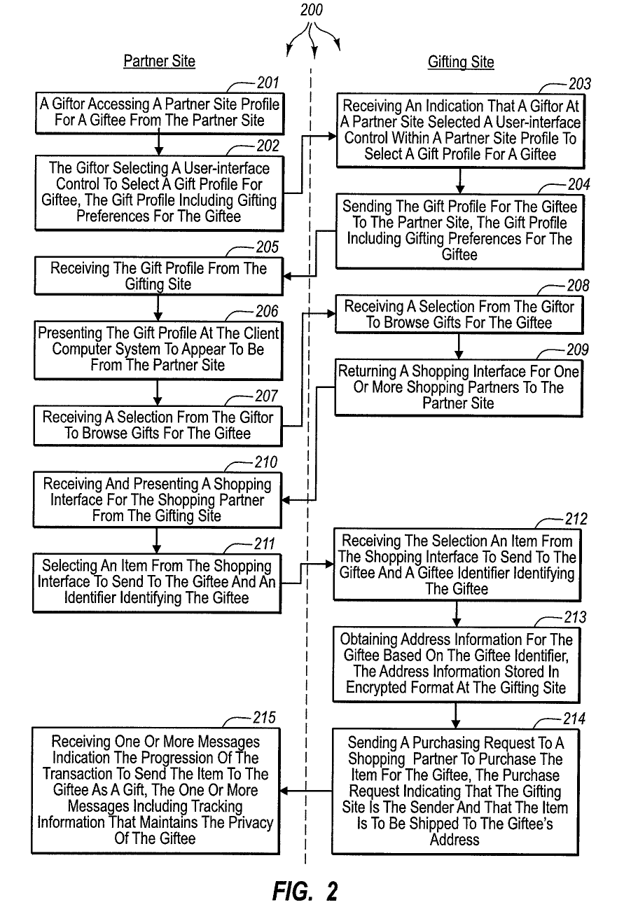

FIG. 2 illustrates a flow chart of an example method 200 for exchanging a gift anonymously. Method 200 will be described with respect to the components and data of computer architecture 100.

Method 200 includes an act of a giftor accessing a partner site profile for a giftee from the partner site (act 201). For example, referring to FIG. 1B, giftor 252 can access a giftee user profile 253 for giftee 251 from partner site 141A. Method 200 includes an act of the giftor selecting a user-interface control to select a gift profile for the giftee (act 202). For example, giftor 252 can select a user-interface control (e.g., a link) presented by partner site 141A to select a gift profile for giftee 251. The user-interface control can link back to gifting site 101 and provide gifting site 101 with information, such as, for example, gift profile ID 211, for identifying giftee gift profile 271. Method 200 includes an act of receiving an indication that a giftor at the partner site selected a user-interface control within a partner site profile to select a gift profile for a giftee (act 203). For example, gifting site 101 can receive an information, such as, for example, gift profile ID 211, that giftor 252 selected a user-interface control within giftee user profile 253 to select giftee gift profile 271.

Method 200 includes an act of an act of sending the gift profile for the giftee to the partner site, the gift profile including gifting preferences for the giftee (act 204). For example, gifting site 101 can send giftee gift profile 271 to partner site 141A. Gift profile 271 includes gifting preferences for giftee 251. Method 200 includes an act of receiving the gift profile from the gifting site (act 205). For example, partner site 141A can receive giftee gift profile 271 from gifting site 101.

Method 200 includes an act of presenting the gift profile at the client computer system to appear to be from the partner site (act 206). For example, partner site 141A can direct gifting profile 271 for presentation to giftor 252. Method 200 includes an act of receiving a selection from the giftor to browse gifts for the giftee (act 207). For example, giftor 252 can select an option to browse gifts for giftee 251 from giftee gift profile 271. In response, partner site 141A can send browsing request 212 to gifting site 101.

Method 200 includes an act of receiving a selection from the giftor to browse gifts for the giftee (act 208). For example, gifting site 101 can receive browsing request 212 from partner site 141A. Based on browsing request 212, electronic commerce module 102 can formulate shopping interface 291 (which is similar to shopping interface 300) for shopping sites (including shopping partner 142B) that are likely to have items of interest to giftee 251 based on gift profile 271. Method 200 includes an act of returning a shopping interface for the shopping partner to the partner site (act 209). For example, gifting site 101 can return shopping interface 291 to partner site 141A.

Method 200 includes an act of receiving and presenting a shopping interface for one or more shopping partners from the gifting site (act 210). For example, partner site 141A can receive and present shopping interface 291 to giftor 252. Method 200 includes an act of selecting an item from the shopping interface to send to the giftee (act 211). For example, giftor 252 can select an item from shopping interface 291 to send to giftee 251. In response to the gift selection, partner site 141A can submit gift purchase 292 to electronic commerce module 102. Gift purchase 292 can include gift ID 268 (for giftee 251).

Method 200 includes an act of an act of receiving the selection an item from the shopping interface to send to the giftee and a giftee identifier identifying the giftee (act 212). For example, gifting site 101 can receive gift purchase 292 from partner site 141. Method 200 includes an act of obtaining address information for the giftee based on the giftee identifier, the address information stored in encrypted format at the gifting site (act 213). For example, gifting site 101 can obtain address information from giftee 251 from encrypted information stored in database 107.

Method 200 includes an act of sending a purchasing request to a shopping partner to purchase the item for the giftee, the purchase request indicating that the gifting site is the sender and that the item is to be shipped to the giftee's address (act 214). For example, gifting site 101 can send gift purchase 297, including giftee address 257, to shopping partner 142B.

Shopping partner 142B can process gift purchase 297 and ship out a purchased item to giftee 251. Shopping partner 142B can return order recipient 293 and shipping confirmation 294 back to gifting site 101. Order tracking 106 can utilize order recipient 293 and shipping confirmation 294 to track the progress of gift purchase 297. Order tracking 106 can store order recipient 293 and shipping confirmation 294 in order tracking data 281 for use in responding to status inquiries related to gift purchase 297. Order tracking 106 can utilize order tracking data 281 and interact with shipping companies 123 to provide tracking information that preserves the anonymity of giftee 251 and giftor 252.

From time to time, gifting site 101 can update giftee 251 and/or giftor 252 indicating the progression of gift purchase 297. Method 200 includes an act of receiving one or more messages indicating the progression of the transaction to send the item to the giftee as a gift, the one or more messages including tracking information that maintains the privacy of the giftee (act 215). For example, message 296 can be received at one or more of giftee site inbox 255, giftor site inbox 256, giftee gift inbox 263 and giftor gift inbox 264. Message 296 can include sufficient information for tracking delivery of a purchases item without revealing personally identifiable information of giftee 251 or giftor 252.

Accordingly, embodiments of the invention facilitate conducting electronic commerce transactions while maintaining anonymity of a gift recipient relative to a gift sender. For example, online friends can exchange gifts in the physical world while maintaining privacy. Embodiments of the invention can be integrated into existing social networking and dating Web sites to provide additional user benefits on behalf of the Web sites. Social networking and dating Web sites can partner with online stores that pay the social networking and dating Web sites a commission on generated sales. A gifting site can implement a privacy fee to maintain user privacy. The privacy fee can be assessed to each transaction to purchase a gift.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a partner site computer system that is connected via network communication to a client computer system and a gifting system, the partner site computer system having one or more processors and system memory, a method for anonymously exchanging a gift, the method comprising:
an act of a giftor accessing a partner site profile for a giftee from the partner site;
an act of the giftor selecting a user-interface control to select a gift profile for giftee;
an act of receiving the gift profile from the gifting site;
an act of presenting the gift profile at the client computer system to appear to be from the partner site;
an act of receiving a selection from the giftor to browse gifts for the giftee;
an act of receiving and presenting a shopping interface for one or more shopping partners from the gifting site;
an act of selecting an item from the shopping interface to send to the giftee and an identifier identifying the giftee; and
an act of receiving one or more messages indicating the progression of the transaction to send the item to the giftee as a gift, the one or more messages including tracking information that maintains the privacy of the giftee.

2. The method as recited in claim 1, wherein the act of selecting an item from the shopping interface to send to the giftee comprises an act of selecting a first item from a first store tab for a first shopping partner; and further comprising:
an act of selecting a second item from the shopping interface to send to the giftee, the second item selected from a second store tab for a second shopping partner.

3. The method as recited in claim 2, further comprising:
an act of interfacing with an electronic commerce module to provide a unified shopping cart and check out experience for purchasing the first item from the first shopping partner and the second item from the second shopping partner.

4. The method as recited in claim 3, further comprising an act of the gifting site adding a privacy fee to the purchase price for the first and second items.

5. The method as recited in claim 1, wherein the act of presenting the gift profile at the client computer system to appear to be from the partner site comprises an act of presenting gift preferences for the giftee.

6. The method as recited in claim 1, wherein the act of receiving one or more messages indicating the progression of the transaction comprises an act of receiving an indication that the item was delivered to the city and state of the giftee without revealing any personally identifiable information about the giftee.

7. At a gifting site computer system that is connected via network communication with partner sites and shopping partners, the gifting site computer system including a processor and system memory, a method for anonymously exchanging a gift, the method comprising:
an act of receiving an indication that a giftor at a partner site selected a user-interface control within a partner site profile to select a gift profile for a giftee;
an act of sending the gift profile for the giftee to the partner site;
an act of receiving a selection from the giftor to browse gifts for the giftee;
an act of returning a shopping interface for one or more shopping partners to the partner site;
an act of receiving the selection an item from the shopping interface to send to the giftee and a giftee identifier identifying the giftee;
an act of obtaining address information for the giftee based on the giftee identifier, the address information stored in encrypted format at the gifting site;
an act of sending a purchasing request to a shopping partner to purchase the item for the giftee, the purchase request indicating that the gifting site is the sender and that the item is to be shipped to the giftee's address.

8. The method as recited in claim 7, further comprising prior to sending the gift profile an act of checking the gift profile to determine if the giftor is permitted to send gifts to the giftee.

9. The method as recited in claim 7, wherein the act of sending the gift profile for the giftee to the partner site comprises an act of sending a gift profile that includes gifting preferences for the giftee.

10. The method as recited in claim 7, wherein the act of receiving the selection of an item from the shopping interface to send to the giftee comprises an act of receiving a selection of a first item from a first store tab for a first shopping partner; and further comprising:
an act of receiving a selection of a second item from the shopping interface to send to the giftee, the second item selected from a second store tab for a second shopping partner.

11. The method as recited in claim 10, further comprising:
an act of interfacing with the partner site to provide a unified shopping cart and check out experience for purchasing the first item from the first shopping partner and the second item from the second shopping partner.

12. The method as recited in claim 11, further comprising an act of adding a privacy fee to the purchase price for the first and second items.

13. The method as recited in claim 7, further comprising:
an act of formulating one or more messages indicating the progression of the transaction to send the item to the giftee as a gift; and
an act of anonymizing the messages such that the messages can be presented to the giftor and/or the giftee without divulging private information about either party.

14. The method as recited in claim 7, wherein the act of formulating one or more messages indicating the progression of the transaction comprises an act of formulating an indication that the item was delivered to the city and state of the giftee without revealing any personally identifiable information about the giftee to the giftor.

15. The method as recited in claim 7, wherein the partner site is one of a social networking site and a dating site.

16. At a gifting site including computer system with one or more processors and system memory, a method for configuring anonymous gift exchange, the method comprising:
an act of receiving an indication that a partner site desires to participate in anonymous gift giving;
an act of configuring a Web service to interact with the partner site such that the partner site does not have to be modified to interact with the gifting site; and
an act of utilizing the Web service to receive data to establish a relationship between the gifting system and partner site such that the partner site can interact with other partner sites to participate in anonymous gift giving transactions.

17. The method as recited in claim 16, wherein the partner site is a social networking site.

18. The method as recited in claim 16, wherein the partner site is a shopping partner.

19. The method as recited in claim 16, wherein the act of utilizing the Web service to receive data comprises:
an act of receiving profile data from a partner site profile;
an act of populating a gift profile at the gifting site with the profile data from the partner site profile.

20. The method as recited in claim 16, further comprising:
an act of using cascading style sheets to configure a user interface for a shopping parent from the received data.
